(19) United States
(12) Patent Application Publication
(10) Pub. No.: US 2013/0262760 A1
(43) Pub. Date: Oct. 3, 2013

(54) RAID DATA STORAGE SYSTEM

(71) Applicant: INTERNATIONAL BUSINESS MACHINES CORPORATION, Armonk, NY (US)

(72) Inventors: Yi-Hsin Cheng, New Taipei City (TW); Chien-Hua Huang, New Taipei City (TW); Kelvin WP Huang, Zhonghe City (TW); Nian-Guang Lee, Tainan (TW); Brent W. Yardley, Hillsboro, OR (US)

(73) Assignee: INTERNATIONAL BUSINESS MACHINES CORPORATION, Armonk, NY (US)

(21) Appl. No.: 13/770,271

(22) Filed: Feb. 19, 2013

(30) Foreign Application Priority Data
Mar. 30, 2012 (TW) 101111296

(51) Int. Cl. G06F 3/06

(52) U.S. Cl. CPC G06F 3/0689
USPC 711/114

(57) ABSTRACT

A data storage system comprises at least one data storage module, each data storage module having at least a first I/O port and a second I/O port, wherein the data storage module includes a storage medium having at least a first pre-partitioned area and a second pre-partitioned area. The data storage system further comprises a first controller module, which is directly connected to the first I/O port of each data storage module to access the first pre-partitioned area of each data storage module, and a second controller module, which is directly connected to the second I/O port of each data storage module to access the second pre-partitioned area of each data storage module.

### CROSS-REFERENCE TO RELATED APPLICATIONS

This application claims priority under 35 U.S.C. §119 to Taiwan Patent Application No. 101111296, filed on Mar. 30, 2012, the entire text of which is specifically incorporated by reference herein.

### BACKGROUND

1. Field of the Invention

The present invention relates to a data storage system, and particularly to a Redundant Array of Inexpensive Disks or Redundant Array of Independent Disks (RAID) data storage system.

2. Background of the Related Art

Existing storage arrays generally have enough redundancy, so that when there is a malfunction in a storage device within one of the storage arrays, the information contained in the malfunctioning storage device can be reconstructed from the other storage devices in that storage array. In general, for the purpose of redundancy, multiple controller modules may be used in a RAID system, and any of the multiple controller modules may be used to operate the whole RAID system.

### BRIEF SUMMARY

One embodiment of the invention provides a data storage system, comprising at least one data storage module, each data storage module having at least a first I/O port and a second I/O port, wherein the data storage module includes a storage medium having at least a first pre-partitioned area and a second pre-partitioned area. The data storage system further comprises a first controller module, which is directly connected to the first I/O port of each data storage module to access the first pre-partitioned area of each data storage module, and a second controller module, which is directly connected to the second I/O port of each data storage module to access the second pre-partitioned area of each data storage module.

Another embodiment of the invention provides a computer system, comprising a host and at least one data storage module, each data storage module having at least a first I/O port and a second I/O port, wherein the data storage module includes a storage medium having at least a first pre-partitioned area and a second pre-partitioned area. The computer system further comprises a first controller module in communication with the host, which is directly connected to the first I/O port of each data storage module to access the first pre-partitioned area of each data storage module, and a second controller module in communication with the host, which is directly connected to the second I/O port of each data storage module to access the second pre-partitioned area of each data storage module.

### BRIEF DESCRIPTION OF THE SEVERAL VIEWS OF THE DRAWINGS

In order that the advantages of the various embodiments will be readily understood, a more particular description of the various embodiments briefly described above will be provided by reference to specific exemplary embodiments that are illustrated in the accompanying drawings, which depict only exemplary embodiments and are not to be considered to be limiting in scope. The various embodiments are to be described and explained with additional specificity and detail through the use of the accompanying drawings.

FIG. 1 is a diagram of a computer system according to an embodiment of the present invention.

FIG. 2 is a diagram of a data storage system according to an embodiment of the present invention

### DETAILED DESCRIPTION

One embodiment of the invention provides a data storage system, comprising at least one data storage module, each data storage module having at least a first I/O port and a second I/O port, wherein the data storage module includes a storage medium having at least a first pre-partitioned area and a second pre-partitioned area. The data storage system further comprises a first controller module, which is directly connected to the first I/O port of each data storage module to access the first pre-partitioned area of each data storage module, and a second controller module, which is directly connected to the second I/O port of each data storage module to access the second pre-partitioned area of each data storage module.

Generally, in the data storage system adopting multiple controller modules, the data storage module (e.g. hard drive) have a plurality of I/O ports, each being connected to the corresponding controller module. Each data storage module, for example a hard drive, is pre-partitioned with multiple storages, and a controller module can access the storage of the data storage module controlled by the data storage module via the corresponding I/O port. In other words, a plurality of controller modules may simultaneously access different storages in a single data storage module (i.e. physically inseparable data storage module) via the individual I/O ports, and a single data storage module can be simulated as multiple data storage modules. Since each storage (simulated storage module) is accessed by the controller module via a dedicated I/O port, data transmission in different storages can be processed at the same time.

In addition, each storage in a single data storage module is controlled by the corresponding controller module via the dedicated I/O port, and thus the storage can have a separate and independent configuration in cooperation with its controller module in the case of the data transfer rate is not affected. For example, the storages belonging to different controller modules can be used for different RAID levels and mutually independent disk arrays. Furthermore, a plurality of controller modules mentioned above can also be provided as redundancy for one another.

Another embodiment of the invention provides a computer system, comprising a host and at least one data storage module, each data storage module having at least a first I/O port and a second I/O port, wherein the data storage module includes a storage medium having at least a first pre-partitioned area and a second pre-partitioned area. The computer system further comprises a first controller module in communication with the host, which is directly connected to the first I/O port of each data storage module to access the first pre-partitioned area of each data storage module, and a second controller module in communication with the host, which is directly connected to the second I/O port of each data storage module to access the second pre-partitioned area of each data storage module.

<Computer System>

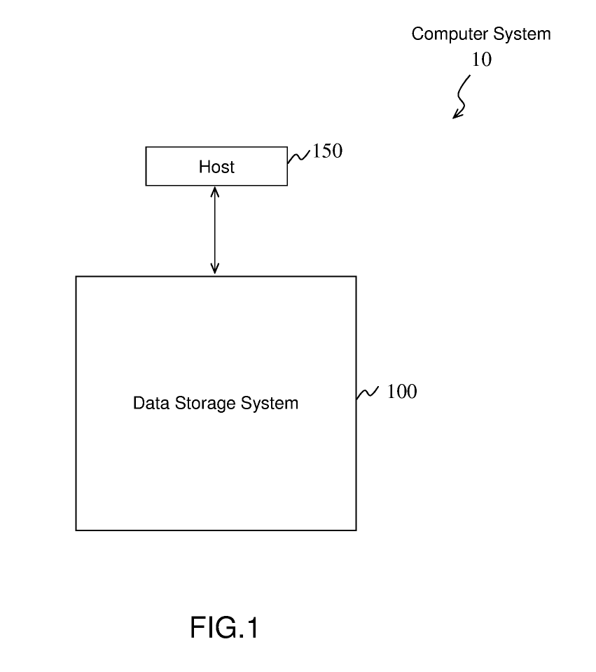

FIG. 1 shows a block diagram of a computer system 10 in accordance with one embodiment. The computer system includes a data storage system 100 and one or more hosts 150 (only a host 150 is shown). The host 150 may be a server, such as IBM's System X, Blade Center, or eServer (available from International Business Machines Incorporated of Armonk, N.Y.).

The host 150 and the data storage system 100 can be connected through a local bus, local area network, Internet, or other data transmission channel for data communication. In other words, the data storage system 100 may form Network Attached Storage (NAS), a Storage Area Network (SAN), or Direct Attached Storage (DAS), but the present invention is not limited to this.

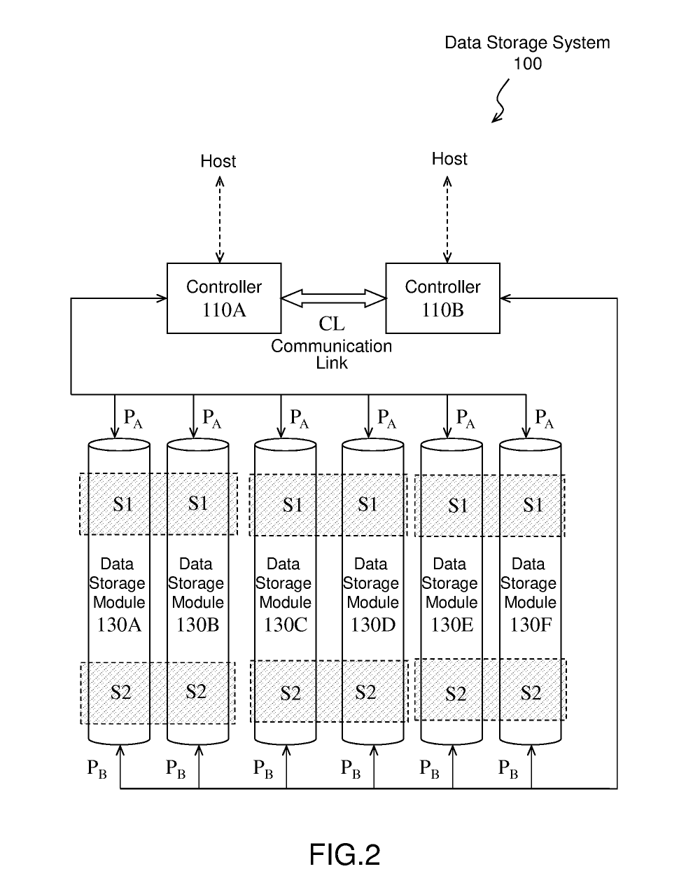

Furthermore, as shown in FIG. 2, the data storage system 100 has two controller modules 110A, 110B. It should be noted that the data storage system 100 may include more controller modules (not shown), and the present invention is not limited to this. More details about the controller modules 110A, 110B will be described hereinafter. The data storage modules 130A-130F may be, without limitation, hard disk drives, flash memory, random access memory (RAM), CD-ROM, tape drives or other readable/writable data storage media.

Preferably, the data storage system 100 has two controller modules, such as the first and second controller modules 110A, 110B. The first and second controller modules 110A, 110B communicate with each other through a communication link (also referred to as fabric) CL, and serve as “redundancy” for each other, such that a write or read performed by one of the two controller modules 110A, 110B will be mirrored to the other of the two controller modules. Accordingly, if one of the two controller modules 110A, 110B is damaged, the other controller module can fail-over and take control immediately.

The data storage modules 130A-130F are preferably, but not limitedly, executed as the same data storage medium. It should be noted that in the present embodiment, each of the data storage modules 130A-130F is a respective “physically inseparable” single data storage module and has its separate package. Accordingly, in normal use, each data storage module is unable to be further partitioned physically. In addition, in the embodiment, each of the data storage modules 130A-130F has an expandable number of I/O ports (not shown), such as each module having three, four, or more I/O ports, to cooperate with additional controller modules (not shown) in the forging data storage system 100.

<Data Storage System>

In a preferred embodiment as shown in FIG. 2, the data storage modules 130A-130F are all hard disk drives, but the data storage system 100 may have more hard disk drives (not shown) or data storage modules. In a non-limiting example, the data storage modules 130A-130F are all implemented as SAS (Serial Attached SCSI) hard drives that each have two I/O ports. The two I/O ports for the six data storage modules 130A-130F in FIG. 2 are respectively labeled as P_{A} and P_{B}. The first I/O port P_{A} for each of the data storage modules 130A-130F is directly connected to the first controller module 110A, and the second I/O port P_{B} for each of the data storage modules 130A-130F is directly connected to the second controller module 110B. It should be noted that, the so-called “direct connection” or “direct path” in this description means that there are no elements capable of processing or controlling the data to be written to, or read from, the data storage modules 130A-130F on a link path (although there may be one or more elements providing data transfer or routing function). It should be noted that the number of the I/O ports for the data storage modules 130A-130F in the present invention is not limited to two as shown in the embodiment of FIG. 2, but can be three, four, or more I/O ports for connecting to other controller modules.

<Pre-Partition>

The storage of each of the data storage modules 130A-130F is pre-partitioned into a first area S1 and a second area S2. The pre-partition settings can be stored in firmware (not shown) of the controller modules 110A, 110B. The pre-partition of each of the data storage modules 130A-130F in the present invention is determined in accordance with the purpose of the subsequent application, but the present invention does not want to specifically limit it.

For example, but without limitation, the first area S1 and the second area S2 in “any” of the data storage modules 130A-130F may have the same size. More preferably, but without limitation, the first area S1 and the second area S2 in each of the data storage modules 130A-130F may have the same size, such that the six data storage modules generate 12 areas with the same size (six areas S1 and six areas S2).

In another embodiment, the first area S1 in each of the data storage modules 130A-130F is the same, but the second area S2 in each of the data storage modules 130A-130F is not necessarily the same. That is, six storages S1 with the same size are generated, while six storages S2 are generated with a size that is different that the six storages S1.

It should also be noted that in other embodiments, the storage of each of the data storage modules 130A-130F can be partitioned according to the number of the I/O ports or the number of the controller modules in the data storage system 100.

<Partition Application: Multiple RAIDs>

Hereinafter, an application embodiment of the data storage system 100 is described in conjunction with FIG. 2. In this embodiment, the first area S1 and the second area S2 of each data storage modules 130A-130F may have the same size. That is, the size of six areas S1 and that of the six areas S2 is the same.

In Normal mode, the first controller module 110A is designed to exclusively access the first area S1 in each of the data storage modules 130A-130F via the I/O port P_{A} of each of the data storage modules 130A-130F. More preferably, but not limitedly, the first area S1 of a first set of two of the data storage modules 130A, 130B, the first area S1 of a second set of two of the data storage modules 130C, 130D, and the first area S1 of a third set of two the data storage modules 130E-130F are respectively paired by the first controller module 110A and are “regarded” as a single disk. Accordingly, six of the first areas S1 are regarded as a total of three disks, as shown in FIG. 2 (see shaded areas with dashed outlining).

Similarly, the second controller module 110B is designed to exclusively access the second area S2 in each of the data storage modules 130A-130F via the I/O port P_{B} of each of the data storage modules 130A-130F. More preferably, but not limitedly, the second area S2 of a first set of two of the data storage modules 130A, 130B, the second area S2 of a second set of two of the data storage modules 130C, 130D, and the second area S2 of a third set of two of the data storage modules 130E-130F are respectively paired by the second controller module 110B and are “regarded” as a single disk. Accordingly, six of the second areas S2 are regarded as a total of three disks, as shown in FIG. 2 (see shaded areas with dashed outlining).

In this way, the data storage module is still maintained in the original six entities (i.e. data storage modules 130A-130F). In terms of each pair of logical disks in the first area S1 (or second area S2), an end user will regard them as a single entity when using them, but actually they are configured in different data storage modules, by which the I/O access, performance and efficiency can be accelerated. In this design, the pre-partition and pairing of storage in each of the data storage modules 130A-130F described above (i.e. the size of six areas S1 and six areas S2 is equally partitioned as well as the two are paired) would have an advantage that a user may “feel” that the data storage system 100 provides three physical disks with the same size for use (i.e. three disks controlled by the first controller module 110A or three disks controlled by the second controller module 110B), instead of being confined to the real size of each of the data storage modules 130A-130F. If the data storage modules 130A-130F originally have storages with the same size, and each of the data storage modules 130A-130F is “partitioned as 50-50” as to the first area S1 and the second area S2, according to the aforementioned pre-partition and pairing (i.e. the size of the six areas S1 and the six areas S2 are equally partitioned as well as the two are paired), the effect of six pairs of logical disks (regarded as six single entities) provided by the data storage system 100 in terms of storage is equivalent to the data storage modules 130A-130F prior to the partition, and users will not even notice the difference with regard to this.

Although a pair of “partitioned” logical disks (regarded as a single entity) may have the same size as an original individual data storage module, the difference lies in that a pair of “partitioned” logical disks are composed by the two storage areas in two data storage modules (e.g. two areas S1). Accordingly, the first controller module 110A can transfer data to a pair of “partitioned” logical disks by using the two I/O ports P_{A} in the two data storage modules, which increases the data transfer efficiency compared to a first controller module 110A that can only transfer data to a single I/O port P_{A} in a single data storage module.

However, it should be apparent to those skilled in the art that if cooperated with other application, the present invention can also allow the first controller module 110A and second controller module 110B to have different numbers or different sizes of logical disks. For example, the first controller module 110A may control three pairs of logical disks composed by the six areas S1 in which two areas are paired respectively, while the second controller module 110B may control two pairs of logical disks composed by four areas S2 in which two areas are paired respectively, and the remaining two areas S2 can be idle or used for other applications and are even not necessarily controlled by the second controller module 110B.

In a preferred embodiment, the first controller module 110A can use the respectively controlled three pairs of logical disks (regarded as three single entities) as a level 5 RAID (i.e. RAID-5), while the second controller module 110B can use the respectively controlled two of the three pairs of logical disks (regarded as two single entities) as a level 1 RAID (i.e. RAID-1). A remaining pair of logical disks (or simply two unpaired areas S2) can be idle or used for any other purpose.

According to the preferred embodiment, those skilled in the art should understand that the present invention can employ the existing hardware architecture of the data storage system to allow each of the different controller modules to have its control of the disk array and to simultaneously write or read data to the disk array under control respectively. Furthermore, compared with existing data storage systems, in this embodiment, each pair of logical disks (regarded as a single entity) are composed by storage areas of two data storage modules, and thus the I/O ports of the two data storage modules are provided for the controller module to access, which further increases the speed of data transfer. In addition, since each pair of “partitioned” logical disks are actually composed of the storage areas of two data storage modules, as the “partitioned” logical disks are applied as RAIDs, in fact, the data storage location will be more dispersed (i.e. the aforementioned RAID-5 controlled by the first controller module 110A is actually dispersed in the six areas S1 across the six data storage modules 130A-130F). Accordingly, the risk of data damage or loss due to a breakdown of an individual data storage module is also reduced.

In addition, in the embodiment as shown in FIG. 2, the first and second controller modules 110A, 110B provide redundancy for each other. For example, in the normal mode, three pairs of logical disks (composed by the pairs of the six areas S1) are controlled by the first controller module 110A (i.e. the first controller module 110A is the “owner”), and the other three pairs of logical disks (composed by the pairs of six areas S2) are controlled by the second controller module 110B. However, if the first controller module 110A is damaged, the second controller module 110B can access data storage modules 130A-130F via the I/O ports P_{B}, and thus the second controller module 110B can also fail-over to control the three pairs of logical disks originally belonging to (“owned by”) the first controller module 110A, and vice versa.

It is worthy to note that the embodiment as shown in FIG. 2 is only interpreted with two controller modules 110A, 110B and the two I/O ports P_{A} and P_{B} of each of the data storage modules 130A to 130F. However, those skilled in the art will understand that, in the case that a system having more controller modules and more I/O ports per data storage module, the number of the controller modules and I/O ports of each data storage module are preferably the same. However, embodiments of the present invention are not limited to a particular the number or ratio of controller modules, data storage modules, and data paths.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A data storage system, comprising:
at least one data storage module, each data storage module having at least a first I/O port and a second I/O port, wherein the data storage module includes a storage medium having at least a first pre-partitioned area and a second pre-partitioned area;
a first controller module, which is directly connected to the first I/O port of each data storage module to access the first pre-partitioned area of each data storage module; and
a second controller module, which is directly connected to the second I/O port of each data storage module to access the second pre-partitioned area of each data storage module.

2. The data storage system of claim 1, wherein the at least one data storage module is a plurality of data storage modules.

3. The data storage system of claim 2, wherein the first pre-partitioned area of each data storage module is the same size.

4. The data storage system of claim 2, wherein the first pre-partitioned area of each data storage module is the same size as the second pre-partitioned area of each data storage module.

5. The data storage system of claim 2, wherein the plurality of data storage modules include a first number of the data storage modules, wherein the first pre-partitioned area of the first number of data storage modules form a first disk array controlled by the first controller module.

6. The data storage system of claim 5, wherein the plurality of data storage modules include a second number of the data storage modules, wherein the second pre-partitioned area of the second number of data storage modules form a second disk array controlled by the second controller module.

7. The data storage system of claim 6, wherein the first number is not the same as the second number.

8. The data storage system of claim 6, wherein the first and second disk arrays are both RAID arrays, and wherein the first RAID array has a first RAID level and the second RAID array has a second RAID level that is not the same as the first RAID level.

9. The data storage system of claim 2, wherein the first controller module controls a combination of logical disks as a single entity.

10. The data storage system of claim 9, wherein the combination of logical disks includes a pair of first pre-partitioned areas.

11. A computer system, comprising:
a host;
at least one data storage module, each data storage module having at least a first I/O port and a second I/O port, wherein the data storage module includes a storage medium having at least a first pre-partitioned area and a second pre-partitioned area;
a first controller module in communication with the host, which is directly connected to the first I/O port of each data storage module to access the first pre-partitioned area of each data storage module; and
a second controller module in communication with the host, which is directly connected to the second I/O port of each data storage module to access the second pre-partitioned area of each data storage module.

12. The computer system of claim 11, wherein the at least one data storage module is a plurality of data storage modules.

13. The computer system of claim 12, wherein the first pre-partitioned area of each data storage module is the same size.

14. The computer system of claim 12, wherein the first pre-partitioned area of each data storage module is the same size as the second pre-partitioned area of each data storage module.

15. The computer system of claim 12, wherein the plurality of data storage modules include a first number of the data storage modules, wherein the first pre-partitioned area of the first number of data storage modules form a first disk array controlled by the first controller module.

16. The computer system of claim 15, wherein the plurality of data storage modules include a second number of the data storage modules, wherein the second pre-partitioned area of the second number of data storage modules form a second disk array controlled by the second controller module.

17. The computer system of claim 16, wherein the first number is not the same as the second number.

18. The computer system of claim 16, wherein the first and second disk arrays are both RAID arrays, and wherein the first RAID array has a first RAID level and the second RAID array has a second RAID level that is not the same as the first RAID level.

19. The computer system of claim 12, wherein the first controller module controls a combination of logical disks as a single entity.

20. The computer system of claim 19, wherein the combination of logical disks includes a pair of first pre-partitioned areas.
